(19) United States
(12) Patent Application Publication
(10) Pub. No.: US 2021/0080770 A1
(43) Pub. Date: Mar. 18, 2021

(54) LIQUID CRYSTAL DISPLAY DEVICE

(71) Applicant: Japan Display Inc., Tokyo (JP)

(72) Inventors: Lu JIN, Tokyo (JP); Shinichiro OKA, Tokyo (JP); Yosuke HYODO, Tokyo (JP)

(21) Appl. No.: 17/007,312

(22) Filed: Aug. 31, 2020

(30) Foreign Application Priority Data
Sep. 12, 2019 (JP) 2019-165965

(51) Int. Cl. G02F 1/1339; G02F 1/1368; G02F 1/1362; G02F 1/1337

(52) U.S. Cl. CPC G02F 1/13394; G02F 1/1368; G02F 1/136209; G02F 2201/121; G02F 2001/13398; G02F 2201/123; G02F 1/1337

(57) ABSTRACT

The purpose of the present invention is to suppress a displacement between the TFT substrate and the counter substrate in lateral direction in the liquid crystal display device. An example of the concrete structure is: a liquid crystal display device comprising: a TFT substrate, in which pixel electrodes are formed, a counter electrode, in which a black matrix is formed, the TFT substrate and the counter substrate being adhered by a sealing material, a liquid crystal being sealed inside from the sealing material, wherein a spacer is formed on either one of the TFT substrate or the counter substrate, a polymer pole is formed around the spacer and in contact with the spacer, a space between the TFT substrate and the counter substrate is maintained by the spacer.

### CLAIM OF PRIORITY

The present application claims priority from Japanese Patent Application JP 2019-165965 filed on Sep. 12, 2019, the content of which is hereby incorporated by reference into this application.

### BACKGROUND OF THE INVENTION

### (1) Field of the Invention

The present invention relates to the display devices, specifically, the liquid crystal display devices that can be bent flexibly.

### (2) Description of the Related Art

In the liquid crystal display device, a TFT substrate, on which the thin film transistors (TFT) and the pixel electrodes are arranged in matrix, and the counter substrate are disposed oppose to each other, and the liquid crystal layer is sandwiched between the TFT substrate and the counter substrate. A transmittance of light is controlled in each of the pixels, thus, images are formed.

When a space between the TFT substrate and the counter substrate fluctuates, a thickness of the liquid crystal layer changes; this causes a non-uniformity in brightness or an evenness in color. Generally, pole spacers are formed on the counter substrate to keep a space between the TFT substrate and the counter substrate constant.

The space between the TFT substrate and the counter substrate can be controlled by the pole spacers; however, the pole spacers cannot control a displacement in lateral direction between the TFT substrate and the counter substrate; the displacement in lateral direction means a displacement in a direction of the major surfaces of the TFT substrate and the counter substrate. When the displacement between the TFT substrate and the counter substrate in lateral direction occurs, the pixel electrode formed on the TFT substrate and the color filter or the black matrix formed on the counter substrate deviate, which causes a color contamination, a color unevenness and non-uniformity in brightness.

Patent document 1 through patent document 3 disclose: monomers are dispersed in the liquid crystal; the liquid crystal is irradiated with an ultra violet ray through a hole in the black matrix to polymerize the monomers; and thus, so called polymer wall is formed. The polymer wall adheres to both the TFT substrate and the counter substrate; thus, lateral deviation between the TFT substrate and the counter substrate is suppressed.

Patent document 1: Japanese patent application laid open No. 2003-195273

Patent document 2: Japanese patent application laid open No. 2012-73421

Patent document 3: Japanese patent application laid open No. 2017-15787

### SUMMARY OF THE INVENTION

The liquid crystal display device can be used in curved state by making glass substrates thin that constitute the TFT substrate and the counter substrate. Alternatively, the flexibly bendable liquid crystal display device can be made by forming the TFT substrate and the counter substrate by resin like polyimide. When the display is curved, a radius of curvatures is different between the TFT substrate and the counter substrate; thus, a deviation in a space or a displacement in a direction of major surfaces (herein after, a lateral direction) between the TFT substrata and the counter substrate occurs. Among them, a deviation in a space between the TFT substrate and the counter substrate can be suppressed by appropriately displacing the pole spacers.

The pole spacers, however, cannot counter measure the displacement in lateral direction. In the meantime, a technology is being developed that: monomers are dispersed in the liquid crystal; the liquid crystal is locally irradiated with an ultra violet ray to polymerize the monomers in the liquid crystal to form a polymer wall or polymer pole; and thus, to control a space between the TFT substrate and the counter substrate. By the way, the name of polymer wall can be used for a pole, however, in this specification, the term of polymer pole is used to avoid confusion.

The polymer pole contacts with both the TFT substrate and the counter substrate; thus, it is effective to prevent a lateral displacement between the TFT substrate and the counter substrate. However, a long and continuous irradiation with the ultra violet ray, e.g. for fifteen minutes, is necessary to form the polymer pole. Such a long irradiation with ultraviolet ray not only lengthens a through put time but also deteriorates the layers irradiated with the ultra violet ray.

The purpose of the present invention is to make the polymer pole in short time, and thus, to realize the liquid crystal display device that maintains a proper spacer between the TFT substrate and the counter substrate, as well as can avoid displacement in lateral direction between the TFT substrate and the counter substrate.

The present invention solves the above explained problems; the concrete measures are as follows.

(1) A liquid crystal display device comprising:

a TFT substrate, in which pixel electrodes are formed,

a counter electrode, in which a black matrix is formed,

the TFT substrate and the counter substrate being adhered by a sealing material,

a liquid crystal being sealed inside from the sealing material,

wherein a spacer is formed on either one of the TFT substrate or the counter substrate,

a polymer pole is formed around the spacer and in contact with the spacer,

a space between the TFT substrate and the counter substrate is maintained by the spacer.

(2) A liquid crystal display device comprising:

a TFT substrate, in which pixel electrodes are formed,

a counter substrate, in which a black matrix is formed,

the TFT substrate and the counter substrate being adhered by a seal material,

a liquid crystal being sealed inside from the sealing material,

wherein a first spacer, which is columnar shape, is formed on either one of the TFT substrate or the counter substrate,

a second spacer is formed on another one of the TFT substrate or the counter substrate,

the first spacer and the second spacer are set with a gap to each other in a plan view,

a polymer pole is formed between the first spacer and the second spacer and on outer surfaces of the first spacer and the second spacer,

a space between the TFT substrate and the counter substrate is maintained by the first spacer in a plan view.

### BRIEF DESCRIPTION OF THE DRAWINGS

FIG. 1 is a plan view of the liquid crystal display device;

FIG. 2 is a cross sectional view in which the liquid crystal of FIG. 1 is curved;

FIG. 3 is another cross sectional view in which the liquid crystal of FIG. 1 is curved;

FIG. 4 is a cross sectional view that shows a process to form a polymer pole;

FIG. 5 is another cross sectional view that shows a process to form a polymer pole following FIG. 4;

FIG. 6 is yet another cross sectional view that shows a process to form a polymer pole following FIG. 5;

FIG. 7 is a cross sectional view that shows a process to form a polymer pole according to embodiment 1;

FIG. 8 is another cross sectional view that shows a process to form a polymer pole following FIG. 7;

FIG. 9 is yet another cross sectional view that shows a process to form a polymer pole following FIG. 8;

FIG. 10 is a cross sectional view of the liquid crystal display device according to embodiment 1;

FIG. 11A is a plan view of the pole spacer of example 1 of embodiment 2;

FIG. 11B is a cross sectional view of FIG. 11A along the line A-A;

FIG. 11C is a cross sectional view that the material for the alignment film is coated on the structure of FIG. 11B;

FIG. 11D is a cross sectional view after levelling of the material for the alignment film;

FIG. 11E is a cross sectional view that a polymer pole is formed according to example 1 of embodiment 2;

FIG. 12A is a cross sectional view of example 2 of embodiment 2;

FIG. 12B is a plan view of FIG. 12A;

FIG. 13A is a cross sectional view of example 3 of embodiment 2;

FIG. 13B is a top view or bottom view of FIG. 13A;

FIG. 14 is a perspective view of example 4 of embodiment 2;

FIG. 15A is a perspective view of example 5 of embodiment 2;

FIG. 15B is a plan view of the pole spacer and the polymer pole of example 5 of embodiment 2;

FIG. 16A is a perspective view of example 6 of embodiment 2;

FIG. 16B is a plan view of the pole spacer and the polymer pole of example 6 of embodiment 2;

FIG. 17A is a plan view of the pole spacer of example 7 of embodiment 2;

FIG. 17B is a plan view of the pole spacer and the polymer pole of example 7 of embodiment 2;

FIG. 18A is a plan view of the pole spacer of example 8 of embodiment 2;

FIG. 18B is a plan view of the pole spacer and the polymer pole of example 8 of embodiment 2;

FIG. 19 is a perspective view of the pole spacer of example 9 of embodiment 2;

### DETAILED DESCRIPTION OF THE PREFERRED EMBODIMENTS

The present invention is explained in the following embodiments in detail.

### Embodiment 1

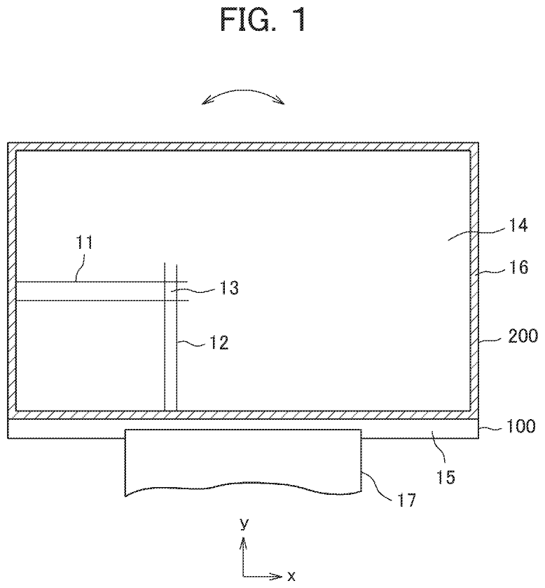

The in-vehicle display device is sometimes used in a state as the display area is curved. FIG. 1 is a plan view of the display device in which the display area is to be used in curved state. In FIG. 1, in screen 14, the lateral dimension is larger than the longitudinal dimension. When the display device is completed, it is curved in a direction of the arrow. In FIG. 1, the TFT substrate 100 and the counter substrate 200 are adhered to each other by the sealing material 16, and the liquid crystal is sealed thereinside by the sealing material.

The display area 14 is formed where the TFT substrate 100 and the counter substrate 200 overlap each other. The terminal area 15 is formed where the TFT substrate 100 does not overlap the counter substrate 200; the flexible wiring substrate 17 connects to the terminal area 15. Powers, scan signals, video signals and etc. are supplied from the flexible wiring substrate 17 to the liquid crystal display device.

In the display area 14 of FIG. 1, the scan signal lines 11 extend in lateral direction (x direction) and are arranged in longitudinal direction (y direction); the video signal lines extend in longitudinal direction and are arranged in lateral direction. The pixel 13 is formed in the area surrounded by the scan signal lines 11 and the video signal lines 12. The pixel electrode and the TFT for controlling the pixel electrode are formed in the pixel 13.

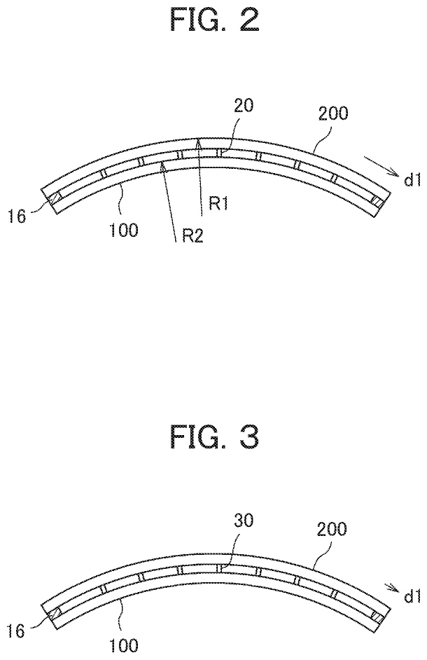

FIG. 2 is a cross sectional view in which the display device of FIG. 1 is curved along the arrow in FIG. 1. In FIG. 2, a tensile stress is generated in the upper portion than the middle line and compressive stress is generated in the lower portion than the middle line. Namely, different stresses are generated between the TFT substrate 100 and the counter substrate 200, consequently, different radius of curvatures are formed between the TFT substrate 100 and the counter substrate 200. In FIG. 2, the radius of curvature of the counter substrate 200 is R1; the radius of curvature of the TFT substrate 100 is R2.

Due to such stresses, a deviation of a space between the TFT substrate 100 and the counter substrate 200, and a displacement in lateral direction between the TFT substrate 100 and the counter substrate 200 are generated. In FIG. 2, pole spacers 20 are formed between the TFT substrate 100 and the counter substrate 200; thus, a space between the TFT substrate 100 and the counter substrate 200 is maintained by those spacers 20. The pole spacers 20, however, cannot suppress a displacement dl in lateral direction between the TFT substrate 100 and the counter substrate 200.

FIG. 3 is a cross sectional view of the liquid crystal display device in which the polymer poles 30 are used instead of the pole spacers 20. The structure of FIG. 3 is the same as the structure of FIG. 2 except the polymer poles 30 are used instead of the pole spacers 20. The polymer poles 30 adhere to both the TFT substrate 100 and the counter substrate 200. Therefore, the lateral displacement dl between the TFT substrate 100 and the counter substrate 200 can be made small; thus, deterioration in display quality due to curved screen can be avoided

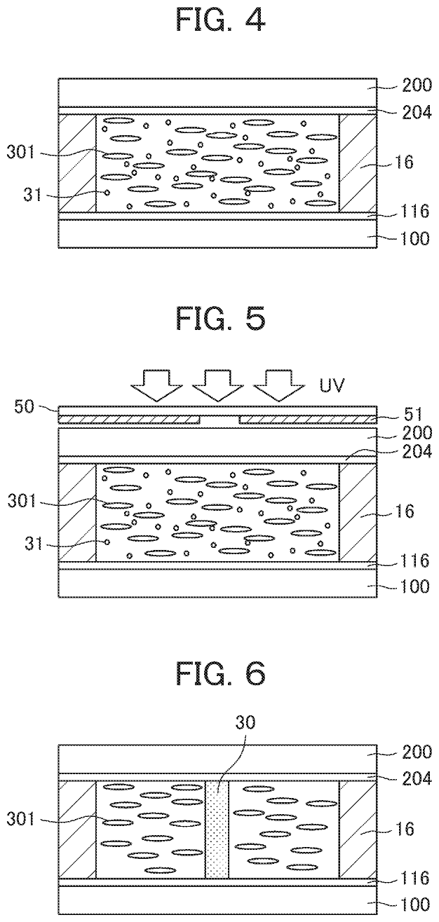

A problem of using the polymer poles is, however, a long processing time for forming the polymer poles 30. FIGS. 4 through 6 are cross sectional views of the liquid crystal display device that shows a process for forming the polymer poles 30. In FIG. 4, the TFT substrate 100 and the counter substrate 200 are adhered to each other by the sealing material 16, and the liquid crystal is sealed thereinside. The liquid crystal contacts with the alignment film 116 formed on the TFT substrate 100 and the alignment film 204 formed on the counter substrate 200. The photopolymerizable monomers 31 are dispersed among the liquid crystal molecules 301 in the liquid crystal. The amount of the photopolymerizable monomers 31 is e.g. 0.5 weight % compared with the liquid crystal. When the ultra violet ray UV is radiated to the photopolymerizable monomers 31, the monomers are polymerized to form a polymer wall or a polymer pole 30.

FIG. 5 is a cross sectional view of the liquid crystal display device in which the ultraviolet ray UV is radiated through a hole in the mask pattern 51 formed on the mask 50. When the ultra violet ray UV is radiated for approximately 15 minutes through the mask 50, polymerization of the monomers 31 progresses at the place where the ultra violet ray UV is radiated, thus, the polymer pole 30 is formed.

FIG. 6 is a cross sectional view of the liquid crystal display device, in which a polymer pole 30 is formed according the above explained process. In FIG. 6, the mask 50 is removed since ultra violet ray UV is not used any more. It takes about 15 minutes to form the polymer pole 30 in the above explained process, in which the ultra violet ray UV is radiated to the photopolymerizable monomers 31 that gathered by diffusing.

A long irradiation with the ultra violet ray UV raises a problem not only a long through put time but also a problem that the layers other than the liquid crystal are also damaged by the ultra violet ray UV. In other words, it gives a danger that a reliability of the liquid crystal display device may be influenced.

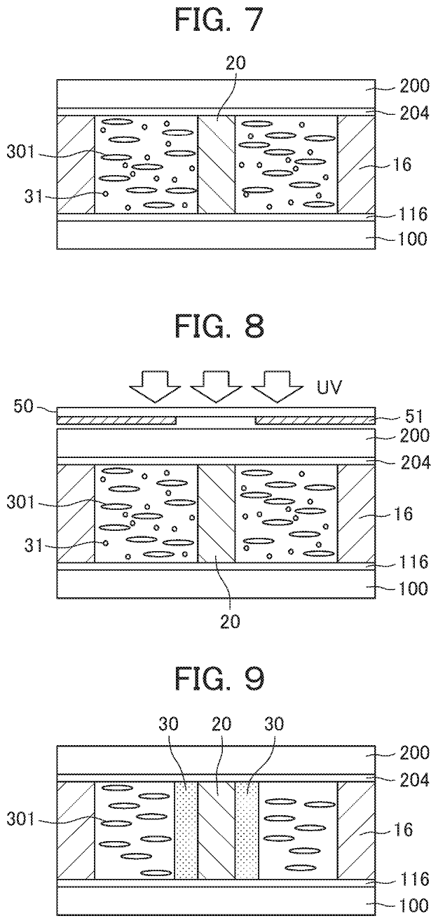

FIGS. 7 through 9 are cross sectional views of the liquid crystal display device that show the structure and the process to form the polymer pole 30 according to the present invention. In FIG. 7, the pole spacer 20 is formed in advance at the place the polymer pole 30 is to be formed. The photopolymerizable monomers 31, which are the material for the polymer poles 30, are dispersed about 0.5 weight % among the liquid crystal molecules 301 in the liquid crystal.

FIG. 8 is a cross sectional view in which the ultra violet ray UV is being radiated to the place where the polymer pole is to be formed. As shown in FIG. 8, the ultra violet ray UV is radiated through the mask 50; the irradiated area includes the pole spacer 20. The inventors found that the pole spacer 20 attracts the photopolymerizable monomers 31. Since the photopolymerizable monomers 31 are attracted to the pole spacer 20, if the ultraviolet ray UV is radiated at the pole spacer 20, polymerization of the photopolymerizable monomers 31 is accelerated, thus, the polymer pole 30 is formed in short time.

FIG. 9 is a cross sectional view that the polymer pole 30 is formed in the vicinity of or in contact with the pole spacer 20. In the structure of FIG. 9, the space between the TFT substrate 100 and the counter substrate 200 is maintained by both the pole spacer 20 and polymer pole 30. In addition, the polymer pole 30 adheres to both the TFT substrate 100 and the counter substrate 200, thus, a displacement between the TFT substrate 100 and the counter substrate 200 in a direction of the major surface, namely a displacement in a lateral direction, can be suppressed.

The ultra violet ray UV develops the polymer pole 30; however, at the same time deteriorates the other organic substances. The liquid crystal display device includes several organic substances as the overcoat film, the alignment film, the organic passivation film and so forth, therefore, if the ultra violet ray UV is radiated to those substances for a long time, those layers are deteriorated. In this invention, since a time for irradiation with the ultra violet ray UV can be shorted, deterioration of those organic substances can be suppressed; consequently, a reliability of the liquid crystal display device can be improved.

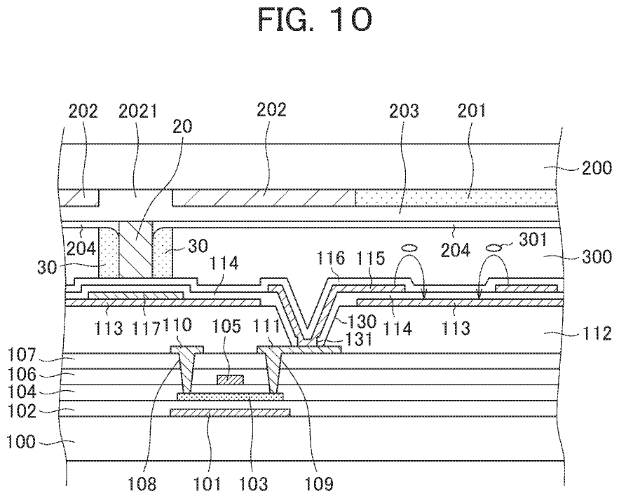

FIG. 10 is a cross sectional view of the liquid crystal display device in which the pole spacer 20 and the polymer pole 30 are formed. As depicted in FIG. 9, the polymer pole 30 is formed in the place where the spacer pole 20 is formed in the present invention. The pole spacer 20 disturbs the alignment of the liquid crystal molecules, therefore, the black matrix 202 is formed on the counter substrate 200 to suppress a leak of light from the back light. The black matrix 202, however, shields the ultra violet ray UV; therefore, the black matrix 202 is eliminated from the places corresponding to the polymer poles 30 are formed in this embodiment. Instead, the light shield film 117 is formed in the TFT substrate 100 at the place corresponding to the polymer pole 30 to prevent a leak of light from the back light. By the way, the auxiliary electrode, which prevents a voltage drop in the common electrode 113, serves as the light shield film 117.

In FIG. 10, the light shield film 101, formed from metal, is formed on the TFT substrate 100, which is formed from glass or resin like polyimide. The metal of the light shield film 101 can be the same metal as the gate electrode 105, which will be explained later. The light shield film 101 prevents the channel of the TFT, which is formed later, from being irradiated with a light from the back light.

Another important role of the light shield film 101 is to prevent the TFT from being influenced by charges accumulated in the TFT substrate 100. Specifically, when the TFT substrate 100 is formed from resin, like polyimide, which easily gets charge up, the TFT tends to be influenced by charges in the TFT substrate 100. The influence of the charge up in the TFT substrate 100 to the TFT, however, can be suppressed by applying a certain voltage to the light shield film 101.

The under coat film 102 is formed covering the light shield film 101. The under coat film 102 prevents the semiconductor film 103, which is formed above the under coat film 101 and constitutes the TFT, from being contaminated by impurities from the TFT substrate 100. The under coat film 102 is often formed from the silicon oxide (herein after SiO) film and the silicon nitride (herein after SiN) film. The aluminum oxide (herein after AlO) film may be added to the under coat film 102.

In FIG. 10, the semiconductor film 103 that constitutes the TFT is formed on the under coat film 102. The oxide semiconductor, the poly silicon, or the a-Si (amorphous Silicon) is formed for the semiconductor film 103. The gate insulating film 104 is formed covering the semiconductor film 103. The gate insulating film 104 tends to be formed from SiO when the semiconductor film 103 is formed from the oxide semiconductor, and formed from SiN when the semiconductor film is formed from the poly silicon or the a-Si. The gate electrode 105 is formed on the gate insulating film 104.

The interlayer insulating film 106 is formed from e.g. SiO covering the gate electrode 105. A thickness of the interlayer insulating film 106 is e.g. 150 nm to 300 nm. The inorganic passivation film 107 is formed from e.g. SiN covering the interlayer insulating film 106. A thickness of the inorganic passivation film 107 is e.g. 100 to 200 nm.

The through holes 108 and 109 are formed penetrating the inorganic passivation film 107, the interlayer insulating film 106 and the gate insulating film 104 to connect the drain electrode 110 with the semiconductor film 103 and to connect the source electrode 111 with the semiconductor film 103. In FIG. 10, the video signal line 12 serves as the drain electrode 110; the source electrode 111 connects with the pixel electrode 115 via through holes 130 and 131.

In FIG. 10, the organic passivation film 112 is formed covering the drain electrode 110 and the source electrode 111. The organic passivation film 112 is formed from e.g. acrylic resin. The organic passivation film 112 serves as a flattening film and also has a role to decrease a floating capacitance between the video signal line 12 and the common electrode 113; therefore, the organic passivation film 112 is made thick as 2 to 4 microns. The through hole 130 is formed in the organic passivation film 112 to connect the source electrode 111 and the pixel electrode 115.

The common electrode 113, formed from the transparent conductive film as e.g. ITO (Indium Tin Oxide), is formed on the organic passivation film 112. The common electrode 113 is formed in planer shape in common to plural pixels. The capacitance insulating film 114, formed from SiN, is formed on the common electrode 113. The pixel electrode 115 is formed from the transparent conductive film as e.g. ITO (Indium Tin Oxide) on the capacitance insulating film 114. The pixel electrode 115 is formed like comb shape. The capacitance insulating film 114 forms a pixel capacitance between the common electrode 113 and the pixel electrode 115.

In the meantime, the common electrode 113 is formed from ITO, which has a larger resistivity than metal. The auxiliary electrode 117, formed from metal, is used to decrease the resistance of the common electrode 113. In this embodiment, the auxiliary electrode 117 serves both as the light shield film 117 against the ultra violet film UV to form the polymer pole 30 and as the light shield film 117 against the light from the back light.

The alignment film 116 is formed covering the pixel electrode 115. The alignment film 116 controls initial alignment direction of the liquid crystal molecules 301. Either a rubbing alignment treatment or a photo alignment treatment using polarized ultra violet ray is used for alignment process. The photo alignment process is profitable in IPS (In Plane Switching) mode liquid crystal display device since the IPS mode does not need a pre-tilt angle.

In FIG. 10, the counter substrate 200 is disposed over the TFT substrate 100 sandwiching the liquid crystal layer 300. The color filter 201 and the black matrix 202 are formed on inner surface of the counter substrate 200; the overcoat film 203 is formed covering the color filter 201 and the black matrix 202. The alignment film 204 is formed on the overcoat film 203. The function of the alignment film 204 and the alignment treatment of the alignment film 203 are the same as explained for the alignment film 116 on the TFT substrate 100.

In FIG. 10, when a voltage is applied between the common electrode 113 and the pixel electrode 115, a line of force as depicted in FIG. 10 is generated to rotate the liquid crystal molecules 301, thus, a light from the back light is controlled. The transmittance of the light is controlled in each of the pixels, consequently, images are displayed.

In FIG. 10, a space between the TFT substrate 100 and the counter substrate 200 is maintained by a pair of the pole spacer 20 and the polymer pole 30. In FIG. 10, the pole spacer 20 is formed on the counter substrate 200. The polymer pole 30 is formed in contact with the pole spacer 20 and is formed around the pole spacer 20. The polymer pole 30 contacts with both the TFT substrate 100 and the counter substrate 200. Therefore, the polymer pole 30 can prevent a displacement between the TFT substrate 100 and the counter substrate 200 in lateral direction, too.

As explained in FIGS. 7 through 9, the polymer pole 30 is formed from the photopolymerizable monomers 31 dispersed in the liquid crystal by irradiating the photopolymerizable monomers 31 with the ultra violet ray UV. The hole 2021 is formed in the black matrix 202 in FIG. 10; and the light shield film 117, stacked on the common electrode 113, is formed to avoid a leak of light from the back light. The light shield film 117 also prevents the organic passivation film 112 from being irradiated with the ultra violet ray UV, which is used to form the polymer pole 30.

The alignment film 204 on the counter substrate 200 is formed after the pole spacer 20 is formed. The alignment film 204 is formed by e.g. offset printing. The material for the alignment film 204 formed by offset printing is baked after levelling, and experiences alignment treatment. During the levelling process, the material for the alignment film moves from the top or the side surface of the pole spacer 20 to a flat area; therefore, the alignment film 204 almost does not remain on the top or the side surface of the spacer pole 20. Consequently, the pole spacer 20 is in a state to contact with the liquid crystal 300, in which the photopolymerizable monomers 31 are dispersed, thus, the photopolymerizable monomers 31 are attracted to the pole spacer 20. As a result, the polymer pole 30 is formed efficiently around the pole spacer 20. FIG. 10 shows that the polymer pole 30 is formed around the pole spacer 20.

### Embodiment 2

Embodiment 2 discloses relations between the various shapes of the pole spacers 20 and the polymer poles 30. It is important to increase a contact area between the pole spacer 20 and the liquid crystal in which the photopolymerizable monomers 31 are dispersed. In the meantime, the material for the alignment film 204 for alignment of the liquid crystal molecules 301 is printed after the pole spacer 20 is formed. The material for the alignment film 204 printed on the pole spacer 20 moves to a flat area by levelling; however, a part of the material for the alignment film 204 remains on a side surface of the pole spacer 20. Therefore, it is important for an efficient formation of the polymer pole 30 how to avoid remaining of the material for the alignment film 204 on the surface of the pole spacer 20, and to keep a large contact area between the surface of the pole spacer 20 and the liquid crystal in which the photopolymerizable monomers 31 are dispersed.

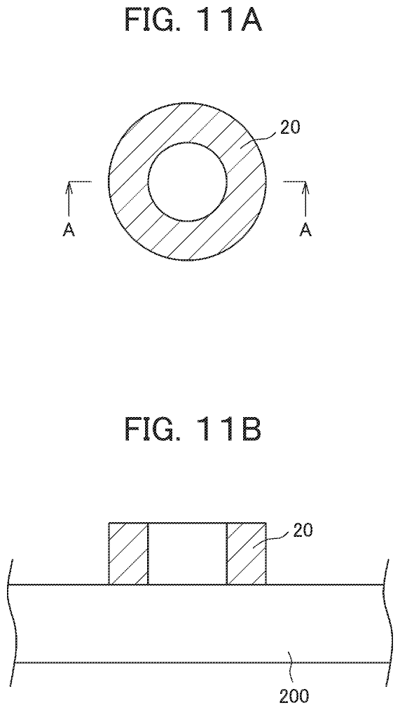

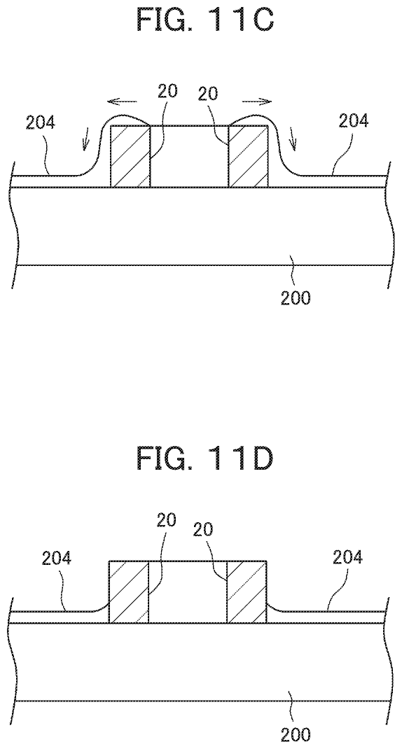

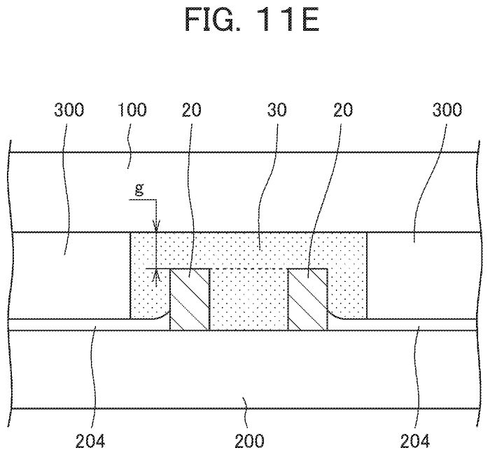

FIGS. 11A through 11E are a first example in embodiment 2, which shows a process how the polymer pole 30 is formed when the pole spacer 20 is cylinder shaped. FIG. 11A is a plan view of the pole spacer 20 formed on the counter substrate 200; FIG. 11B is a cross sectional view of FIG. 11A along the line A-A. The pole spacer 20 is formed in cylinder shape.

FIG. 11C is a cross sectional view that the material for the alignment film 204 is coated on the counter substrate 200. The alignment film 204 is formed from e.g. polyimide; the liquid material for the polyimide is coated by e.g. offset printing. The material for the alignment film 204, which is coated such a manner, does not easily enter a small hollow formed inside of the cylinder shaped pole spacer 20. As a result, the material for the alignment film 204 is coated on the top and on the outer side surface of the pole spacer 20.

The material for the alignment film 204 moves in a direction shown by the arrow in FIG. 11C by levelling effect, as a result, the material for the alignment film 204 remains only a part of the outer surface of the cylindrical pole spacer 20. Therefore, as shown in FIG. 11D, the cylindrical pole spacer 20 can have a large area where the material for the alignment film 204 does not exist. Consequently, the contact area between the pole spacer 20 and the liquid crystal, in which the photopolymerizable monomers 31 are dispersed, can be increased.

FIG. 11E is a cross sectional view in which the polymer pole 30 is formed by irradiating the pole spacer 20 with the ultra violet ray UV according to the above explained process. In FIG. 11E, the TFT substrate 100 is upside and the counter substrate 200 is down side. During the process of forming the polymer pole 30, the photopolymerizable monomers 31 diffuse into the hollow formed inside of the pole spacer 20 through the gap g between the pole spacer 20 and the TFT substrate 100; thus, the polymer pole 30 is efficiently formed.

In FIGS. 11A through 11E, it has been explained that the pole spacer 20 is formed on the counter substrate 200; however, the pole spacer 20 can be formed on the TFT substrate 100. Hereinafter in the embodiments, it is explained that the pole spacer 20 is formed on the TFT substrate 100 for easy perception of the figures. The effect of the pole spacer 20 is the same in either case when the pole spacer 20 is formed on the TFT substrate 100 or on the counter substrate 200.

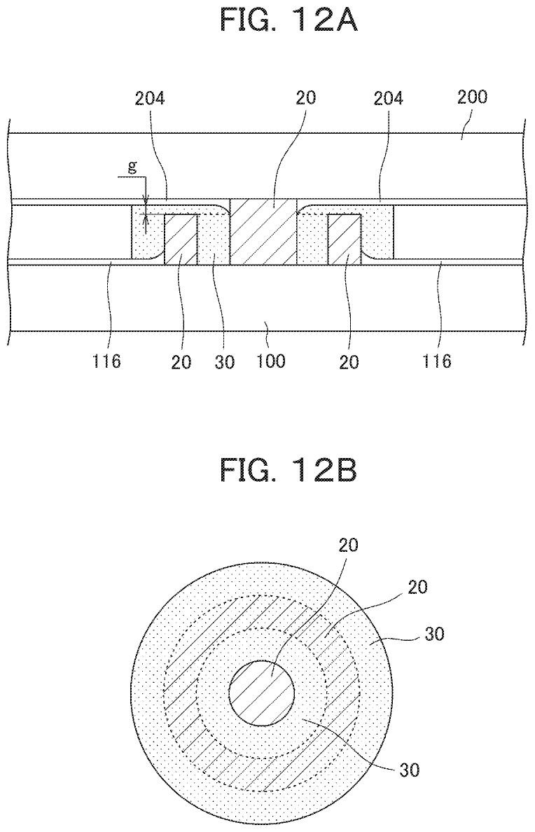

FIGS. 12A and 12B are a second example of the pole spacer 20 and the polymer pole 30 in embodiment 2. FIG. 12A is a cross sectional view in which the columnar pole spacer 20 formed on the counter substrate 200 is inserted into a hollow of the cylindrical pole spacer 20 formed on the TFT substrate 100. As explained in FIGS. 11A through 11D, the material for the alignment film 116 is not coated in the hollow of the cylindrical pole spacer 20. On the other hand, the material for the alignment film 204 exists only on a part of the side surface of the columnar spacer 20. A space between the columnar spacer 20 and the cylindrical spacer 20 is maintained large enough, thus, the polymer pole 30 is formed between the columnar spacer 20 and the cylindrical spacer 20.

In FIG. 12A, the photopolymerizable monomers 31 diffuse into the hollow formed inside of the cylindrical pole spacer 20 through the gap g between the cylindrical pole spacer 20 and the counter substrate 200, thus, the polymer pole 30 develops between the columnar spacer 20 formed on the counter substrate 200 and the cylinder substrate formed on the TFT substrate 100. In addition, the polymer pole 30 develops on the outer surface of the cylinder pole spacer 20, too. Therefore, the polymer pole 30 can be formed efficiently.

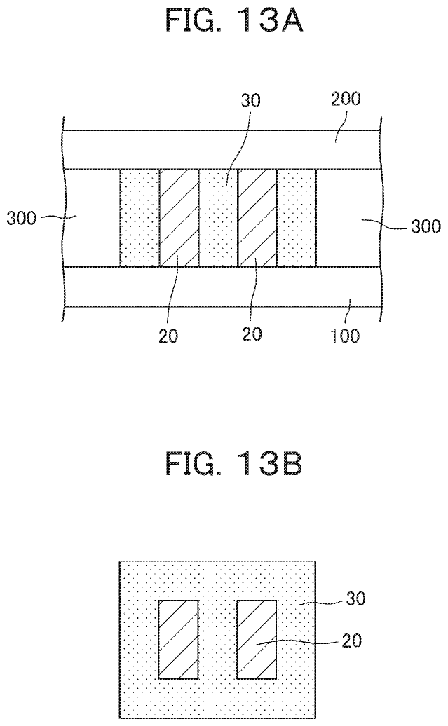

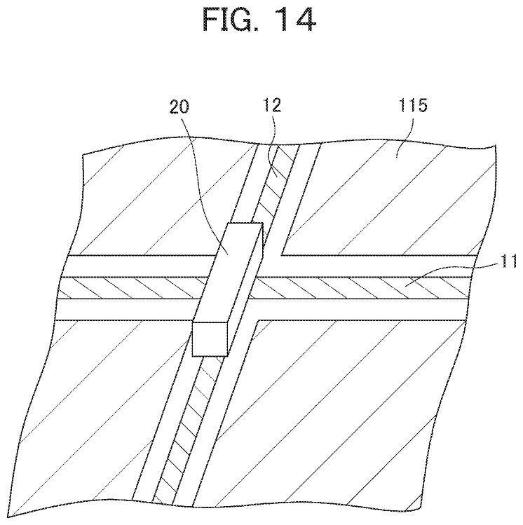

FIGS. 13A and 13B are a third example of embodiment 2. The alignment films are omitted in the following figures. FIG. 13A is a cross sectional view of the pole spacer 20 and the polymer pole 30; FIG. 13B is a plan view when FIG. 13A is viewed from the counter substrate 200 or from the TFT substrate 100. In this embodiment, two pole spacers 20 are formed in pair.

In FIG. 13A a space between the two pole spacers 20 is large enough, thus, the polymer pole 30 is formed in this space. On the other hand, the polymer pole 30 is formed also on the outer side surfaces of the pole spacers 20. In FIGS. 13A and 13B, the polymer pole 30 is formed surrounding the pole spacers 20; the TFT substrate 100 and the counter substrate 200 are adhered to each other by the polymer pole 30.

A space is not formed between the pole spacers 20 and the counter substrate 200 because the photopolymerizable monomers 31 dispersed in the liquid crystal can diffuse into a space between the two pole spacers 20 through sides of the pole spacers 20 during irradiation with the ultra violet ray UV.

FIG. 14 is a fourth example of embodiment 2. It is preferable for the pole spacer 20 to have a large area in the side surface compared with the area of the bottom surface to form the polymer pole 30 efficiently. The pole spacer 20 in this example is a rectangular formed along the extending direction of the video signal line 12 or the extending direction of the scan signal line 11. In such a shape, an area of the side surface can be made large compared with a pole spacer 20 in which a plan view is circle or square. Such a rectangular pole spacer 20 can be formed by setting it at a cross point of the video signal line 12 and the scan signal line 11; consequently, polymer pole 30 can be formed efficiently.

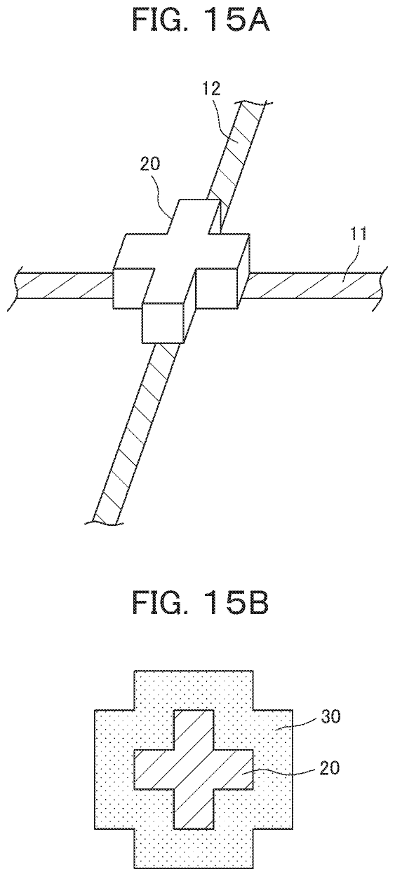

FIGS. 15A and 15B are a fifth example of the pole spacer 20 of embodiment 2. FIG. 15A is a perspective view of the pole spacer 20; FIG. 15B is a plan view of the pole spacer 20 and the polymer pole 30 after the polymer pole 30 is formed. The pole spacer 20 in this example is a combination of the rectangle that has an elongated portion along the scan signal line 11 and the rectangle that has an elongated portion along the video signal line 12, in other words, cross shaped. The pole spacer 20 is located at a cross point of the scan signal line 11 and the video signal line 12. Therefore, the polymer pole 30 can be formed more efficiently.

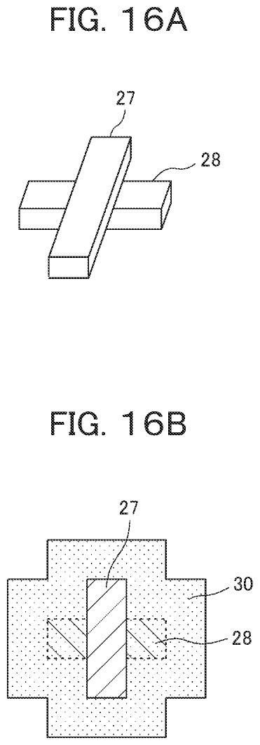

FIGS. 16A and 16B are sixth example of the pole spacer 20 of embodiment 2. FIG. 16A is a perspective view of the pole spacer 20; the rectangular pole spacer 27 formed on the counter substrate 200 and the rectangular pole spacer 28 formed on the TFT substrate 100 are disposed in cross relation. FIG. 16A differs from FIG. 15A in that the polymer pole 30 is formed on the bottom surface of the pole spacer 27, too. FIG. 16B is a plan view of the pole spacer 20 and the polymer pole 30 when viewed from a side of the counter substrate 200. The shape of the polymer pole 30 in FIG. 16B is the same as the shape of the polymer pole 30 in FIG. 15B.

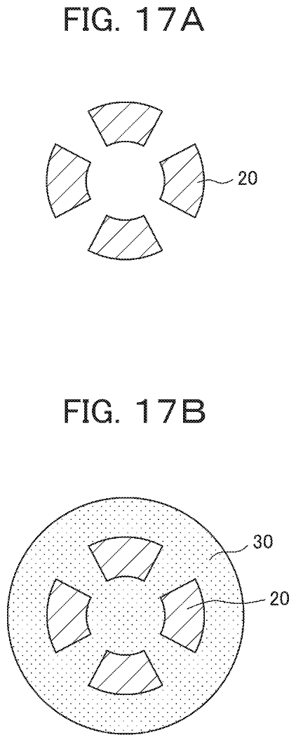

FIGS. 17A and 17B are a seventh example of the pole spacer 20 of embodiment 2. FIG. 17A is a plan view of the pole spacer 20. In FIG. 17A, the cylindrical pole spacer 20 is divided into four, therefore, the photopolymerizable monomers 31 dispersed in the liquid crystal can diffuse into inside of the cylindrical pole spacer 20 through a gap between divided cylindrical pole spacers 20; consequently, the polymer pole 30 can be formed more efficiently than in the case of example 1. The material for the alignment film is not coated inside of the cylindrical pole spacer as explained in example 1.

FIG. 17B is a plan view in which the polymer pole 30 is formed around the pole spacer 20 according to this example. The shape of the polymer pole 30 is approximately the same as that of example 1. In the meantime, the photopolymerizable monomers 31 dispersed in the liquid crystal can diffuse into inside of the cylindrical pole spacer 20 through a gap between divided cylindrical pole spacers 20, therefore, the pole spacer 20 can contact with both the TFT substrate 100 and the counter substrate 200.

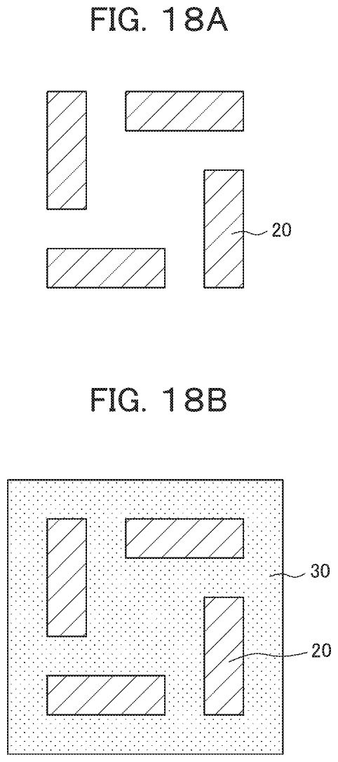

FIGS. 18A and 18B are an eighth example of the pole spacer 20 of embodiment 2, in which one polymer pole 30 is formed from four pole spacers 20. FIG. 18A is a plan view of pole spacer 20 and FIG. 18B is a plan view of the polymer pole 30 and the pole spacer 20. FIGS. 18A and 18B are the same as FIGS. 17A and 17B except that the outer shape in a plan view of the polymer pole 30 is quadrangle.

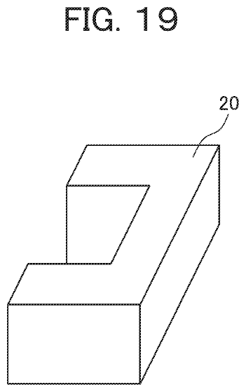

FIG. 19 is a perspective view of ninth example of the pole spacer 20 of embodiment 2. In FIG. 19, the pole spacer 20 is formed from a combination of three linear embodiments in a plan view to increase the area to contact with the liquid crystal in which the photopolymerizable monomers 31 are dispersed; and thus, formation of the polymer pole 30 can be accelerated. The pole spacer 20 of FIG. 19 can contact with both the TFT substrate 100 and the counter substrate 200, or can contact either one of the TFT substrate 100 or the counter substrate 200.

All the structures of examples 1 through 9 of embodiment 2 are characterized in that the pole spacer 20 has an increased contact area with the liquid crystal, in which the photopolymerizable monomers 31 are dispersed, to accelerate polymerization of the monomers by irradiation with the ultra violet ray UV, thus, formation of the polymer pole 30 can be accelerated. Therefore, irradiation time with the ultra violet ray UV can be shortened, consequently, through put can be shortened and the deterioration of the organic layers due to irradiation with the ultra violet ray UV can be suppressed.

What is claimed is:

1. A liquid crystal display device comprising:
a TFT substrate, in which pixel electrodes are formed,
a counter electrode, in which a black matrix is formed,
a sealing material adhered to the TFT substrate and the counter substrate, and
a liquid crystal sealed inside the sealing material,
wherein a spacer is formed on one of the TFT substrate or the counter substrate,
a polymer pole is formed around the spacer and in contact with the spacer, and
a space between the TFT substrate and the counter substrate is maintained by the spacer.

2. The liquid crystal display device according to claim 1,
wherein the polymer pole contacts both the TFT substrate and the counter substrate.

3. The liquid crystal display device according to claim 1,
wherein the spacer that is formed on one of the TFT substrate and the counter substrate is pole shaped.

4. The liquid crystal display device according to claim 1,
wherein, the polymer pole contacts the TFT substrate, the counter substrate and the spacer.

5. The liquid crystal display device according to claim 1,
wherein an alignment film is formed on the TFT substrate and the counter substrate at sides of the liquid crystal.

6. The liquid crystal display device according to claim 1,
wherein the spacer is formed on the counter substrate,
the black matrix is eliminated from a first place where the spacer is formed in a plan view, and
a metal light shield is formed at a second place on the TFT substrate, the second place overlaps the first place in a plan view.

7. The liquid crystal display device according to claim 6,
wherein the metal light shield is formed in stacked manner on a common electrode.

8. The liquid crystal display device according to claim 1,
wherein the spacer formed on one of the TFT substrate and the counter substrate is rectangular, a long side of the spacer is along an extending direction of a scan signal line or along an extending direction of a video signal line formed on the TFT substrate.

9. The liquid crystal display device according to claim 1,
wherein the spacer formed on one of the TFT substrate and the counter substrate is a combination of two rectangular, and
one long side of the spacer is along an extending direction of a scan signal line, another long side of the spacer is along an extending direction of a video signal line.

10. The liquid crystal display device according to claim 1,
wherein the spacer is divided into four in a plan view, a gap is formed between each of the divided spacers.

11. A liquid crystal display device comprising:
a TFT substrate, in which pixel electrodes are formed,
a counter substrate electrode, in which a black matrix is formed,
a sealing material adhered to the TFT substrate and the counter substrate, and
a liquid crystal sealed inside the sealing material,
wherein a first spacer, which is columnar shape, is formed on one of the TFT substrate or the counter substrate,
a second spacer is formed on another one of the TFT substrate or the counter substrate,
the first spacer is arranged adjacent to and spaced from the second spacer,
a polymer pole is formed between the first spacer and the second spacer and on outer surfaces of the first spacer and the second spacer, and
a space between the TFT substrate and the counter substrate is maintained by the first spacer.

12. The liquid crystal display device according to claim 11,
the second spacer is a circular shaped, in a plan view, having a hollow at a center, and
the first spacer is set in the hollow of the second spacer separated with a gap with the second spacer.

13. The liquid crystal display device according to claim 11,
wherein the first spacer and the second spacer are rectangular shaped, a long side of the first spacer and a long side of the second spacer are parallel, and
the first spacer and the second spacer are set to separate with a gap to each other in a plan view.

14. The liquid crystal display device according to claim 11,
wherein the first spacer and the second spacer are rectangular shaped, a long side of the first spacer and a long side of the second spacer are set orthogonally to each other in a plan view.
